(19) United States
(12) Patent Application Publication
(10) Pub. No.: US 2015/0300590 A1
(43) Pub. Date: Oct. 22, 2015

(54) BEAM-CONTROLLABLE HEADLIGHT

(71) Applicant: YUJING TECHNOLOGY CO., LTD., New Taipei City (TW)

(72) Inventor: Cheng-Feng HUANG, New Taipei City (TW)

(73) Assignee: YUJING TECHNOLOGY CO., LTD., New Taipei City (TW)

(21) Appl. No.: 14/258,859

(22) Filed: Apr. 22, 2014

(51) Int. Cl. F21S 8/10

(52) U.S. Cl. CPC F21S 48/1388

(57) ABSTRACT

A beam-controllable headlight has a lamp base, a first reflector and a second reflector. A lighting-emitting panel with a light source is mounted on the rear portion of the lamp base. The first reflector is mounted on the rear portion of the lamp base and has a reflective surface facing the rear portion. The second reflector has two end points. A normal of the light-emitting panel passes through one of the end points of the second reflector, and an acute angle is included between the normal of the light-emitting panel and a straight line passing through the other end point and a point on the light-emitting panel defining the normal of the light-emitting panel. Light beams are reflected twice to rule out scattering light generated above a cutoff line of the headlight and enhance brightness under the cutoff line.

### BACKGROUND OF THE INVENTION

1. Field of the Invention

The present invention relates to a lighting device, and more particularly to a vehicular headlight with reduced glare above a cutoff line of the headlight and enhanced light utilization under the cutoff line.

2. Description of the Related Art

Headlights or fog lights of vehicles serve not only for lighting purpose but also for alerting oncoming vehicles or road users to avoid the risk of collision. However, when the beams of headlights or fog lights directly shine into the eyes of oncoming drivers or road users, there is a likelihood that the oncoming drivers or the road users may have accidents caused by glare as a result of the intensified light beams. Hence, cutoff line regulations of headlights or fog lights are well defined by all countries for land transportation means (especially vehicles and motorcycles). To separate a bright area and a dark area in a beam irradiated from a headlight or a fog light with a cutoff line, the bright area is defined to have a specified brightness at a certain distance from the headlight or the fog area such that the driver can clearly identify obstructions on roads. The dark area is defined to have a controlled light output within a specified distance and a specified angle to avoid glare generation resulting in discomfort and possible danger to oncoming drivers and road users. To tackle strong scattering light generated above the cutoff line, a blocking board is mounted between the light source and the headlight cover of a conventional headlight. The blocking board is even painted black or a front portion of the light source is painted black to form an absorbing layer for light absorption and glare avoidance. Despite reduction of scattering light, the foregoing two ways fail to effectively utilize light energy.

### SUMMARY OF THE INVENTION

An objective of the present invention is to provide a beam-controllable headlight with reduced glare above a cutoff line of the headlight and enhanced light utilization under the cutoff line.

To achieve the foregoing objective, the beam-controllable headlight has a lamp base, a first reflector and a second reflector.

The lamp base has a rear portion, a front portion and a peripheral wall.

The rear portion has a light-emitting panel. The light-emitting panel is planar and has a light source mounted thereon.

The peripheral wall is formed on the rear portion and protrudes toward the front portion.

The first reflector is mounted on the rear portion with a distance to the light-emitting panel less than a distance to the front portion of the lamp base, and has a first reflective surface and two first end points.

The first reflective surface faces the front portion of the lamp base.

One of the first end points is connected to the rear portion of the lamp base. The other first end point is connected to the peripheral wall of the lamp base. An acute angle is included between a straight line passing the two first end points of the first reflector and a normal of the light-emitting panel.

A second reflector is mounted between the rear portion and the front portion of the lamp base and has a second reflective surface and two second end points.

The second reflective surface faces the rear portion of the lamp base.

The normal of the light-emitting panel passes through one of the second end points of the second reflector. An acute angle is included between the normal of the light-emitting panel and a straight line passing through the other second end point and a point on the light-emitting panel defining the normal of the light-emitting panel.

Light beams emitted from the light source are reflected by the second reflector to converge to a focus point of the second reflector, and travel to and are further reflected by the first reflector to parallelly propagate toward the front portion of the lamp base.

The second reflector serves to reflect and focus light beams of the light source on the first reflector for the first reflector to further collimate the light beams propagating toward the front portion of the lamp base, thereby avoiding generation of scattering light above a cutoff line of the headlight and enhancing light utilization under the cutoff line.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a beam-controllable headlight in accordance with the present invention;

FIG. 2 is an exploded perspective view of the beam-controllable headlight in FIG. 1;

FIG. 3 is an enlarged side view in partial section of the beam-controllable headlight in FIG. 1;

FIG. 4 is an operational side view in partial section of the beam-controllable headlight in FIG. 3;

FIG. 5 is an operational side view in partial section of a second reflector and a light source of a second embodiment of a beam-controllable headlight in accordance with the present invention; and

FIG. 6 is another operational side view in partial section of the second reflector and the light source in FIG. 5.

### DETAILED DESCRIPTION OF THE INVENTION

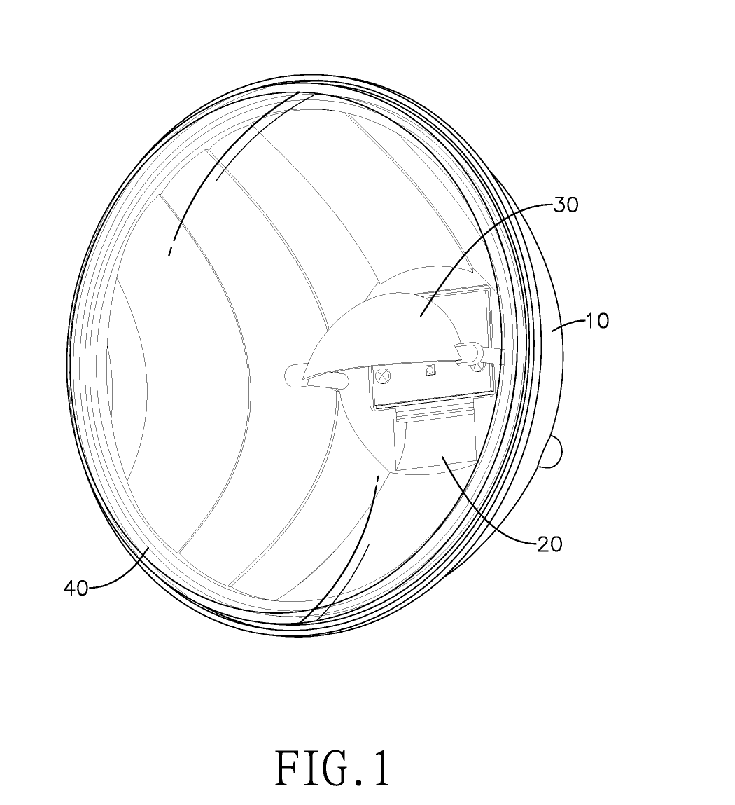

With reference to FIG. 1, a first embodiment of a beam-controllable headlight in accordance with the present invention can be connected to a front end of a vehicle as a headlight of the vehicle and has a lamp base 10, a first reflector 20, a second reflector 30 and a lamp cover 40.

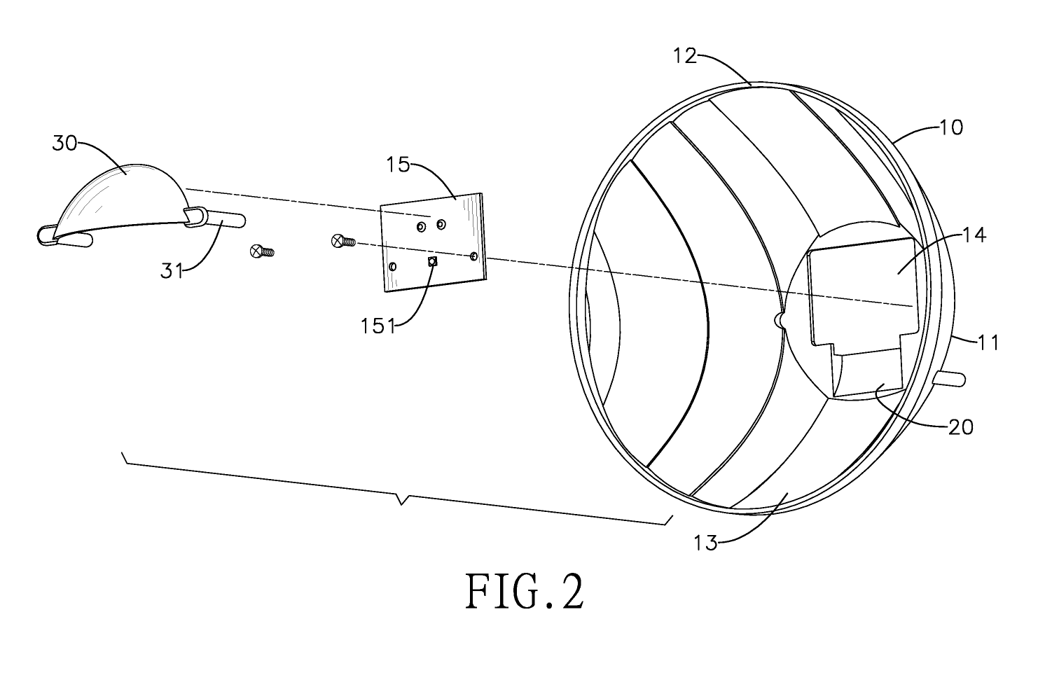

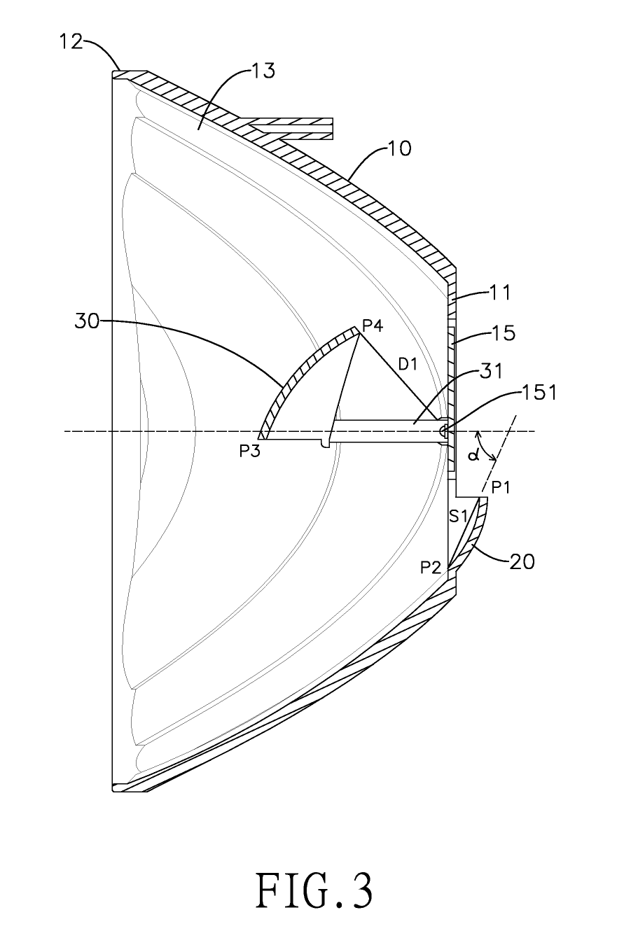

With reference to FIGS. 2 and 3, the lamp base 10 is bowl-shaped, and has an accommodation space, a rear portion 11, a front portion 12 and a peripheral wall 13. The accommodation space is defined within the lamp base 10. The rear portion 11 has an opening 14 and a light-emitting panel 15. The opening 14 is formed through the rear portion 11. The light-emitting panel 15 is planar, is mounted to close the opening 14 for the rear portion 11 to be formed as a closed end, and has a light source 151 mounted thereon. In the present embodiment, the light source 151 is a surface light and a light-emitting diode (LED) light source. The front portion 12 is connected to the lamp cover 40. The peripheral wall 13 is formed on the rear portion 11 and protrudes toward the front portion 12 of the lamp base 10.

The first reflector 20 is mounted on the rear portion 11 of the lamp base 10. A distance between the first reflector 20 and the light-emitting panel 15 is shorter than a distance between the first reflector 20 and the front portion 12 of the lamp base 10. In other words, the first reflector 20 is closer to the rear portion 11 than to the front portion 12. The first reflector 20 has a reflective surface, an arcuate section and two end points P1, P2. The reflective surface faces the front portion 12. One of the two end points P1 is connected to the rear portion 11 of the lamp base 10. The other end point P2 is connected to the peripheral wall 13. An included angle α between a straight line S1 passing through the two end points P1, P2 of the first reflector 20 and a normal of the light-emitting panel 15 is 60 degrees. In the present embodiment, the first reflector 20 and the rear portion 11 of the lamp base 10 are integrally formed.

The second reflector 30 is mounted inside the accommodation space of the lamp base 10, is located between the rear portion 11 and the front portion 12 of the lamp base 10, and has an arcuate section, a reflective surface and two end points P3, P4. The reflective surface faces the rear portion 11 of the lamp base 10. The normal of the light-emitting panel 15 passes through one of the end points P3 of the second reflector 30. An included angle between the normal of the light-emitting panel 15 and a straight line passing through the other end point P4 and a point on the light-emitting panel 15 defining the normal of the light-emitting panel 15 is 60 degrees. In the present embodiment, the second reflector 30 is connected to the rear portion 11 of the lamp base 10 or the light-emitting panel 15 through a connection member 31. The connection member 31 is parallel to the normal of the light-emitting panel 15. The second reflector 30 and the rear portion 11 of the lamp base 10 are integrally formed.

A contour of the lamp cover 40 corresponds to that of a top edge of the front portion of the lamp base 10 to close the lamp base 10.

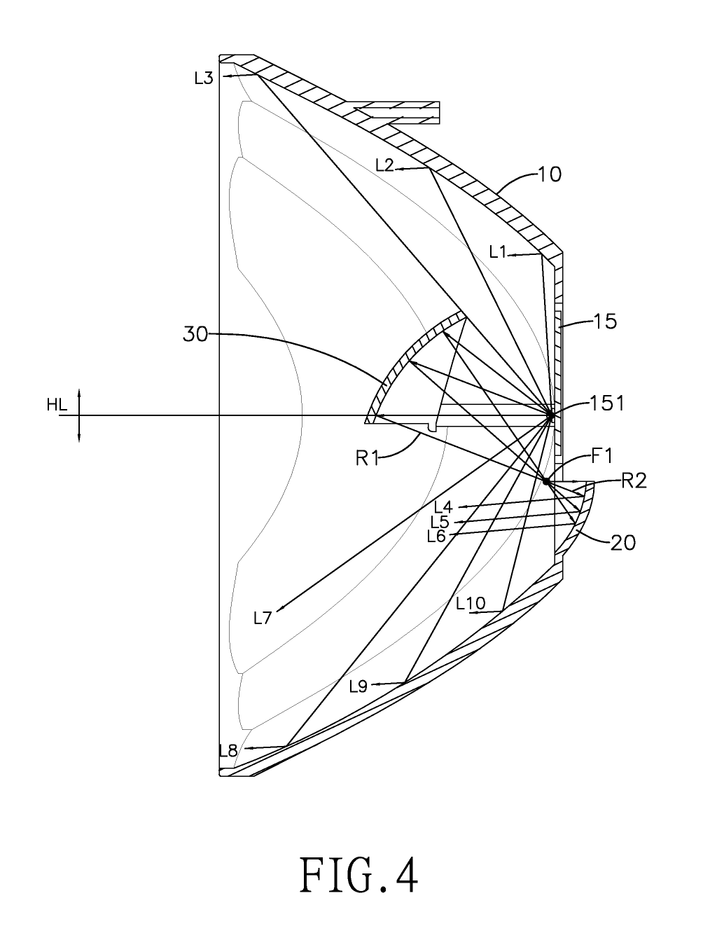

With reference to FIG. 4, when in use, the beam-controllable headlight is connected to a vehicular power supply to light up the light source 151 of the light-emitting panel 15. The light source 151 emits light beams L1, L2, L3, L4, L5, L6, L7, L8, L9 and L10 in a top-down direction. The light beams L4, L5, L6 are irradiated to the second reflector 30 in front of the light source 151, are reflected by the second reflector 30 to travel in a downward direction and converge to a focus point F1 of the second reflector 30, which is located under the light source 151 and is closer to the front end 12 of the lamp base 10 than the first reflector 20. After passing the focus point F1 of the second reflector 30, the light beams L4, L5, L6 further travel to the first reflector 20 and then are reflected by the first reflector 20 to be eventually irradiated through the lamp cover 40 in the form of collimated light beams parallel to and located below a horizontal line HL. Hence, headlights' light beams that are higher than the horizontal line HL and are directly irradiated to the eyes of oncoming drivers and road users can be effectively avoided, and driving accidents caused by visual impairment resulting from glare can be therefore reduced. A first propagation distance of each light beam L4, L5, L6 measured from the second reflector 30 to the focus point F1 is R1. A second propagation distance of each light beam L4, L5, L6 measured from the focus point F1 to the first reflector 20 is R2. The first propagation distance R1 is greater than the second propagation distance R2. According to the optical properties of quadratic surfaces, the light beams L1, L2, L3, L8, L9, L10 are reflected by the peripheral wall 13 of the lamp base 10 to form collimated light beams parallel to the horizontal line HL. Among all the light beams, the light beams L8, L9, L10 are aligned under the horizontal line HL.

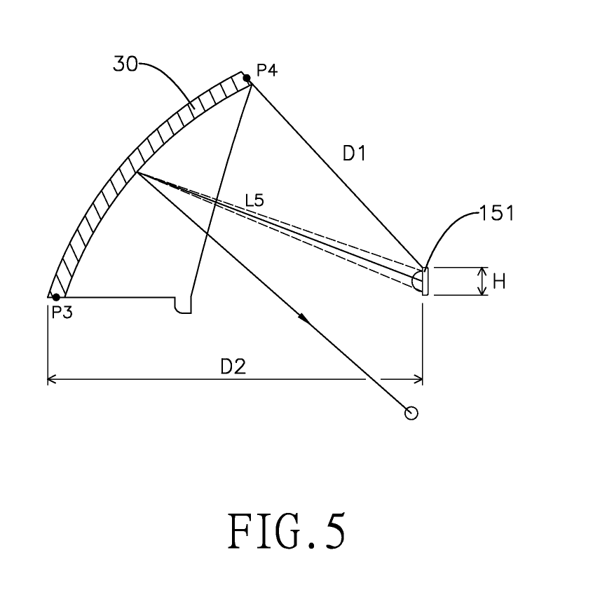

With reference to FIG. 5, operation of a second embodiment of a beam-controllable headlight in accordance with the present invention is shown. A distance D2 between the light source 151 and one of the end points P3 of the second reflector 30 and a distance D1 between the light source 151 and the other end point P4 of the second reflector 30 can be adjusted according to a height of the peripheral wall 13 of the lamp base 10 and a size of the lamp base 10. An angle between a straight line passing the end point P4 of the second reflector 30 and a normal of the light source 151 is 60 degrees. When the light source 151 irradiates light beams to a same point on the second reflector 30, as the light source can be treated as a surface light, a light beam irradiated from a center of the vertical surface light source 151 is taken as a normal. A light divergence angle is defined as an angle between an outmost light beam and the normal of the light source and can be expressed as follows.

$$tan θ = \frac{H / 2}{D}$$

where

θ is a light divergence angle;

H is a size (height) of the light source;

D is a distance between the light source and the second reflector.

When a propagation distance of the light beam L5 from the light source 151 to the second reflector 30 is 34.41 mm, the light divergence angle of the light beam L5 is 3.58 degrees.

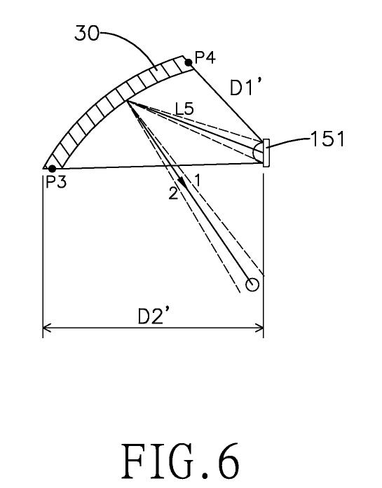

As a comparison for adjustment of the second reflector 30, with reference to FIG. 6, supposing that a size H of the light source remains intact, when a propagation distance D1′ of the light beam L5 from the end point P4 of the second reflector 30 to the light source 151 is less than the propagation distance D1 of the light beam L5 in FIG. 5 (in other words, the angle between the straight line D1′ and the light source 151 is less than 60 degrees) or when a distance D2′ between the end point P3 and the light source 151 is less than the distance D2 in FIG. 5, the light divergence angle is approximately 7.46 degrees, which is larger than that in FIG. 5 because the light beam L5 propagates shorter distance in FIG. 6 than in FIG. 5. Varying the size of the light source and the distance D2 between the end point P3 of the second reflector 30 and the light source 151 and the distance D1 between the end point P4 of the second reflector 30 and the light source 151 can adjust the light divergence angle of light beams emitted from the light source 151. Preferably, the light divergence angle is maintained under 4 degrees as it is efficient for light beams of the light source to be reflected and propagated under the horizontal line HL or the cutoff line.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A beam-controllable headlight, comprising:
a lamp base having:
a rear portion having a light-emitting panel, wherein the light-emitting panel is planar and has a light source mounted thereon;
a front portion; and
a peripheral wall formed on the rear portion and protruding toward the front portion;
a first reflector mounted on the rear portion with a distance to the light-emitting panel less than a distance to the front portion of the lamp base, and having:
a first reflective surface facing the front portion of the lamp base; and
two first end points, wherein one of the first end points is connected to the rear portion of the lamp base, the other first end point is connected to the peripheral wall of the lamp base, and an acute angle is included between a straight line passing the two first end points of the first reflector and a normal of the light-emitting panel;
a second reflector mounted between the rear portion and the front portion of the lamp base, and having:
a second reflective surface facing the rear portion of the lamp base; and
two second end points, wherein the normal of the light-emitting panel passes through one of the second end points of the second reflector, and an acute angle is included between the normal of the light-emitting panel and a straight line passing through the other second end point and a point on the light-emitting panel defining the normal of the light-emitting panel;
wherein light beams emitted from the light source are reflected by the second reflector to converge to a focus point of the second reflector, and travel to and are further reflected by the first reflector to parallelly propagate toward the front portion of the lamp base.

2. The beam-controllable headlight as claimed in claim 1, wherein the second reflector and the rear portion of the lamp base are integrally formed.

3. The beam-controllable headlight as claimed in claim 1, wherein the second reflector is connected to the light-emitting panel through a connection member.

4. The beam-controllable headlight as claimed in claim 1, wherein the second reflector has an arcuate section.

5. The beam-controllable headlight as claimed in claim 1, wherein the acute angle included between the normal of the light-emitting panel and the straight line passing through the other second end point and the point on the light-emitting panel defining the normal of the light-emitting panel is 60 degrees.

6. The beam-controllable headlight as claimed in claim 1, wherein the first reflector and the rear portion of the lamp base are integrally formed.

7. The beam-controllable headlight as claimed in claim 1, wherein the first reflector has an arcuate section.

8. The beam-controllable headlight as claimed in claim 3, wherein an included angle between the straight line passing through the two first end points of the first reflector and the normal of the light-emitting panel is 60 degrees.

9. The beam-controllable headlight as claimed in claim 1, wherein a light divergence angle is defined as an angle between an outmost light beam and a normal of the light source, and the light divergence angle is in a range of 0 degree to 4 degrees.
